(19) United States
(12) Patent Application Publication
(10) Pub. No.: US 2002/0155828 A1
(43) Pub. Date: Oct. 24, 2002

(54) Service configuration in a mobile network

(76) Inventors: Petri Tuomainen, Espoo (FI); Tommi Raivisto, Vantaa (FI)

Correspondence Address: PILLSBURY WINTHROP, LLP, P.O. BOX 10500, MCLEAN, VA, 22102, US

(21) Appl. No.: 10/107,813

(22) Filed: Mar. 28, 2002

Related U.S. Application Data
(63) Continuation of application No. PCT/FI00/00828, filed on Sep. 27, 2000.

(30) Foreign Application Priority Data
Sep. 29, 1999 (FI) 19992091

(51) Int. Cl. H04M 3/42

(52) U.S. Cl. 455/414; 455/412

(57) ABSTRACT

A method of configuring a service (SE) for a mobile station (MS). The mobile station (MS) is able to store directory entries (DE) comprising a name field (41) and telephone number field (42). A service configuration application (SC) receives (2-2) the user's preference information and generates (2-4) a service configuration string (310). It formats (2-6′) a directory entry (DE) such that its name field (41) comprises a service description (312) and the telephone number field (42) comprises the configuration string (310). The directory entry (DE) is stored (2-10) to the mobile station (MS). One of several predefined configuration strings may be selected (5-2) by means of the name field (41). The service (SE) can be configured by placing a call (5-4) to the configuration string stored in the telephone number field.

This application is a Continuation of International Application PCT/FI00/00828 filed on Sep. 27, 2000, which designated the U.S. and was published under PCT Article 21(2) in English.

### BACKGROUND OF THE INVENTION

The invention relates to the configuration of a configurable network service over a user interface of a mobile station.

In the prior art, a service offered to a mobile station is configured in a manner such that as a response to dialling by the user the mobile station sends a USSD string which is interpreted by a receiving mobile exchange. For example, call forwarding to a number 123456 can be implemented by dialling a character string *21*#123456#. This character string, though rather complicated, can only be used for configuring a very simple service: in the above example the call is unconditionally forwarded to a given fixed number. Special characters delivered from a keypad are very difficult to use for configuring a service such as a reachability profile in which a call is attempted, during office hours, first to an office telephone for 5 seconds, next to a mobile phone for 8 seconds and if this fails too, the call is transferred to a voice mail service. Outside office hours the call is first attempted to a home telephone.

A problem in the above arrangement is thus that unreasonable long number strings have to be entered from the user interface of a mobile station. This takes a lot of time and demands great precision from the user. The configuration of the configurable network service can be made easier for the user by generating audible prompts, such as “dial time as hours, minutes and press hash key” or “dial telephone number and press hash key”. A problem in this technique is, for example, that the radio connection has to be allocated to the entire configuration time of the service.

### BRIEF DESCRIPTION OF THE INVENTION

An object of the invention is thus to provide a method and equipment implementing the method so as to solve the above problems. The object of the invention is achieved by a method and equipment, which are characterized by what is stated in the independent claims. The preferred embodiments of the invention are disclosed in the dependent claims.

The invention is based on a novel way of using directory entries of a mobile station for configuring a service. Directory entries are commonly used for storing combinations of names and telephone numbers. The set of directory entries of a mobile station are sometimes referred to as the address book of the mobile station, but because an address field is not necessary for carrying out the invention, the term ‘directory entry’ will be used. The mobile station is able to store directory entries comprising a name field and telephone number field. A service configuration application receives the user's preference information and generates a service configuration string which can be used later to configure the service according to the preference information in question. The preference information is used for creating a directory entry such that the name field of the directory entry comprises a service description and its telephone number field comprises the configuration information string. The directory entry (the telephone number field of which contains the configuration string) is stored to the mobile station or to its SIM card. The above steps have to be performed only once for each different configuration. One of several predefined configuration strings may be selected by means of the name field. The service can be configured by attempting to place a call to the configuration string stored in the telephone number field.

An advantage of the invention is that no changes are required in a mobile telephone. In other words, basic embodiments of the invention can be used by means of handsets with very limited functionality. A user of a basic handset has to create and store the directory entry manually, or via a computer interface if the handset supports it. However, after a configuration string has been stored in the mobile station, it can be used conveniently without manual re-keying.

A preferred embodiment makes use of more advanced protocols, such as the protocols specified in references 1 and 2. According to this embodiment, the service configuration string is formatted on the network side of the radio interface and sent to the mobile station as a business card. The mobile station will notify the user of the received business card, and the user only has to store it. Within the context of the present application, a ‘business card protocol’ means a protocol which supports sending an electronic business card, i.e. a combination of at least a name and a telephone number such that the mobile station user can easily store a received business card as a directory entry.

### BRIEF DESCRIPTION OF THE DRAWINGS

In the following, the invention will be described in more detail by means of preferred embodiments with reference to the accompanying drawings, in which:

FIG. 1 is block diagram illustrating a telecommunication system in which the invention can be used;

FIG. 2A is a signalling diagram illustrating a possible set of events while storing a configuration string;

FIG. 2B shows some optional events which can take place instead of or in addition to those shown in FIG. 2A;

FIG. 3 shows a possible user interface for service configuration;

FIG. 4 shows a directory entry or an electronic business card according to the invention; and

FIG. 5 is a signalling diagram illustrating the use of predefined configuration strings.

### DETAILED DESCRIPTION OF THE INVENTION

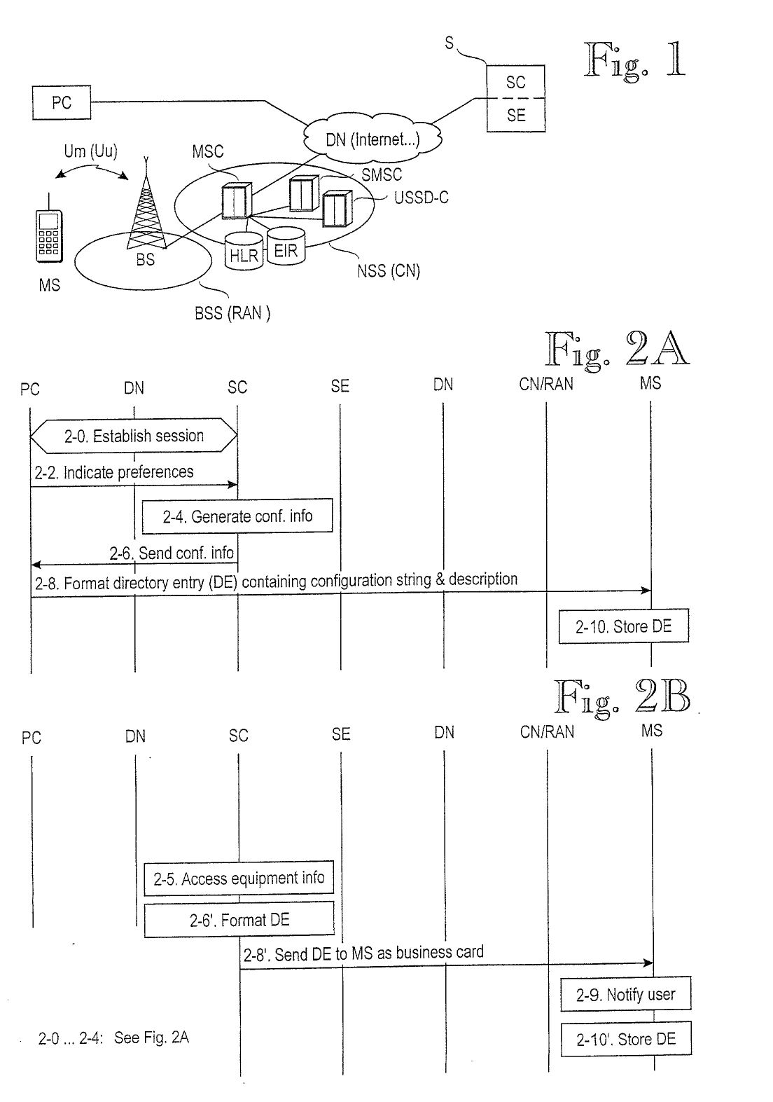

FIG. 1 is block diagram illustrating a telecommunication system in which the invention can be used. A mobile station MS communicates via a radio interface Um, a base station subsystem BSS, a network subsystem NSS and a data network DN with a server S of the service provider. (In third generation systems the radio interface will probably be denoted Uu, the BSS will probably be called a radio access network, RAN, and the NSS will be called a core network, CN). The BSS typically comprises several base stations BS and base station controllers BSC (not shown separately). The NSS typically comprises mobile services switching centres MSC. The data network DN can be e.g. a public switched telephone network (PSTN) or a TCP/IP network, such as the Internet or some closed subnetwork of it, commonly referred to as an intranet or extranet.

For illustrating the invention, let us consider a case wherein the mobile station user owns a yacht. He subscribes to a weather forecast service which transmits weather reports in the form of short messages. In this example, the service has three configurable parameters:

1. the number of transmissions per day,

2. the time span of each forecast, and

3. the area(s) covered by the forecasts.

If multiple services share one common network address, each service must have a service key or code to distinguish it from the other services sharing the same network address. Let us further assume that the user alternates between three different weather forecast configurations. In the winter, he does not want to receive any weather forecasts to his mobile station. In the summer, he has one configuration for workdays and another for weekends and holidays. Assuming that the service key for this service is 101, a typical configuration string for the weekends and holidays may be *101*4*12*051 *052#. This means that the forecast is sent 4 times per day, each forecast covering a time span of 12 hours for area codes 051 and 052. For workdays, his configuration string can be e.g. *101*1*24*051#. For the winter, his configuration string would be *101*0#.

If the user had to key in a different configuration string each time he wanted to change the service configuration, he would very likely enter one or more incorrect parameters. He would also be reluctant to change the configuration frequently, which means that he would either receive (and pay for) too much information during the workdays or he would receive too little information during the holidays. The service provider would also find it difficult to sell the services. It should be kept in mind that the user is likely to subscribe to a few other services as well. For example, he may receive news and/or stock exchange data, and it is probable that the transmission frequency of such services would be lowered during the user's holidays. Yet further, the user is likely to change his reachability profile between workdays and holidays.

According to one embodiment of the invention, the user uses his personal computer PC, having an Internet browser, to establish an Internet session to the server S of the service provider. For the purposes of this embodiment, it is essential that an interactive communication session can be established between the personal computer PC and the server S. The server S comprises two major sections, a service configuration module SC and a service execution module SE. Such modules may be implemented as software routines within one computer. In large-volume applications, the server S may comprise a cluster of computers wherein one set of computers performs the service configuration and another performs the service execution.

FIG. 2A is a signalling diagram illustrating a possible set of events in an arrangement as shown in FIG. 1. In step 2-0 a communication session is established between the personal computer PC and the service configuration module SC of the server S. For example, the PC user selects or keys in the URL address of the service provider, such as “www.weatherservice.fi”. Step 2-0 may comprise authentication of the PC user and, if the service involves confidential information, establishing a secure transmission layer. However, such steps are well known to a skilled reader.

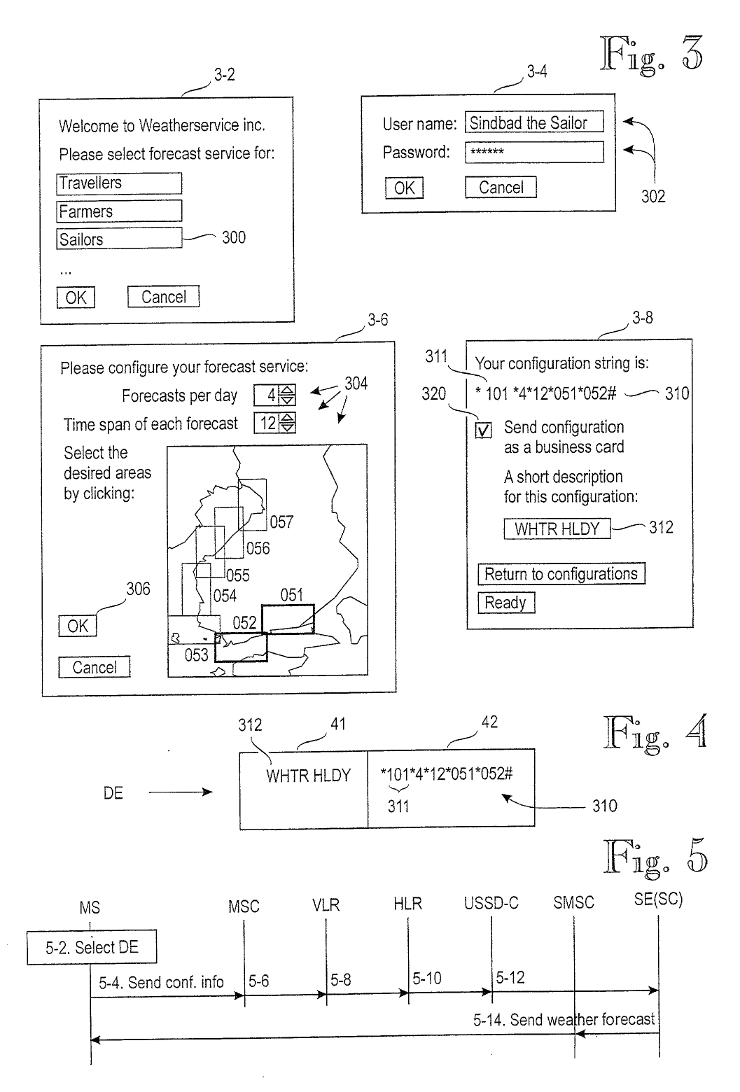

In step 2-2 the PC user indicates his preferences to the SC. This step will be further explained in connection with FIG. 3. (It has been assumed that the PC user and the MS user are one and the same person, but this is not a necessary assumption.) In step 2-4, based on the preference information, the SC determines the appropriate configuration information for the service. Now the configuration information must be conveyed to the mobile station MS. Let us first assume that the MS is a very basic handset which does not support a business card protocol. In step 2-6 the SC builds a web page which includes the appropriate configuration information and sends the web page to the PC. In step 2-8 the PC user may then copy the configuration information from the web page, format it as a directory entry (“DE”) and store it, in step 2-10, to the memory of the MS. Preferably, the configuration information is stored in the SIM (Subscriber Identity Module) card of the MS. Steps 22 to 2-10 are repeated for each configuration string, and the session between the PC and the SC is then terminated.

FIG. 2B illustrates an alternative or optional set of events in an arrangement according to a preferred embodiment of the invention. In this embodiment the service configuration module SC has access to equipment information which indicates that the mobile station MS supports a business card protocol. Steps 2-0 to 2-4 are similar to the ones shown in FIG. 2A. In step 2-5 the SC accesses the equipment information. For example, such equipment information can be stored in the user's subscription data for the service in question. Alternatively, the SC may have access to the Equipment Identity Register EIR of the mobile communication network. The equipment information indicates that the user's MS supports a business card protocol, and consequently, in step 2-6′ the SC formats the configuration information as a directory entry DE (also known as a business card) and, in step 2-8′, sends it to the MS. In step 2-9 the MS user is notified of the received business card, and in step 2-10′ he stores it in the MS (or in the SIM).

FIG. 3 shows a possible user interface for the service configuration module SC. The steps of FIG. 3 relate to steps 2-0 to 2-4 of FIG. 2A. In step 3-2 the PC user selects, from among the various available services, the weather forecast service for sailors 300. In step 3-4 the user's authentication data 302, such as his name and password, are requested (cf. step 2-0). In step 3-6 he indicates his preferences 304 by filling in an appropriate form. The numerical parameters 4 and 12 are entered in conventional number-entry fields, and the two areas 051 and 052 can be selected by clicking anywhere within the corresponding rectangles. A selected area is shown with bold outline.

When the user has finished entering his preferences, and he clicks the OK button 306, the service configuration module SC determines the corresponding configuration information or configuration string 310. The configuration string comprises the service code or identity 311. The remainder of the configuration string comprises or indicates the user's preference information 304. The service configuration module SC sends the configuration string 310 to the user's PC as a web page 3-8 (cf. step 2-6 in FIG. 2A). Preferably, the web page comprises a selector 320, the activation of which begins the transmission of the configuration information as a business card (cf. step 2-6′ in FIG. 2B). Reference sign 312 denotes a short description for the directory entry. Some SIM cards have a 10-character limit for the name of the called subscriber. In this example “WHTR HLDY” means “weather forecast for holiday season”.

According to another embodiment of the invention, the mobile station is WAP-enabled, and the interactive session for configuring the service can be established between the WAP-enabled mobile station and the service configuration module SC.

FIG. 4 shows a directory entry DE according to the invention. The directory entry DE comprises a name field 41 and a telephone number field 42. (The field names indicate the conventional use of these fields.) According to the invention, the name field 41 contains the (mnemonic) service description 312 and the telephone number field 42 contains the configuration string 310 (which in turn comprises the service code 311 and the user's preference information 304). According to a preferred embodiment of the invention, the directory entry is transmitted to the mobile station by using a business card protocol. Within the concept of this application, a ‘business card protocol’ is a protocol which allows sending a combination of a name 41 (i.e. the service description) and a telephone number 42 (i.e. the configuration string) to be stored in the memory of the mobile station. For maintaining compatibility with existing mobile stations and SIM cards, the configuration string should consist only of characters which are allowed in a telephone number, i.e. the numbers 0 to 9, the asterisk (*) and the hash code (#). If the service in question needs characters beyond the allowed character set, the configuration string must be coded into a numerical form by a suitable coding algorithm.

FIG. 5 illustrates selecting one of the predefined directory entries (configuration strings). In step 5-2 the MS user is about to begin his holiday and wants to configure the weather forecast service accordingly. He selects the corresponding configuration information by selecting, from the telephone directory of the mobile station, an entry having the name of “WHTR HLDY”. Even with the 10-character limit, such a mnemonic description is much more convenient and intuitive than manual keying of the configuration string. In step 5-4 the MS user sends the configuration string, for example by placing a call to the telephone number indicated by the directory entry. To be more specific, the MS user acts as he was placing a call to the telephone number indicated by the service description 41 (see FIG. 4). The mobile station MS recognizes that the service description 41 is not a real telephone number but a USSD string, and the MS sends the USSD string (without actually making a call).

In step 5-6 the MSC sends the configuration string 42 to the Visitor Location Register VLR which, in step 5-8, analyses the MS user's IMSI to determine his Home Location Register HLR. In step 5-10 the HLR routes the configuration string 42 to the USSD Service Centre USSD-C serving the user in question. In step 5-12 the USSD-C sends the configuration string to the service execution module SE. Alternatively, the configuration information may be sent to the service configuration module SC, which conveys the information to the SE.

In step 5-14, the service execution module SE of the server S sends, preferably via a short message service centre SMSC, a first weather forecast based on the new configuration information. For example, at 6 a.m., the MS user may receive a short message as follows:

051 6: 15 S4, 9: 17 SSW6, 12: 19 SW8, 15: 21 WSW10, 18: 20 W9

052 6: 16 SE3, 9: 18 S5,12: 20 SSW6, 15: 22 SW9, 18: 20 WSW9

The first row means that in the area 051, at 6 o'clock in the morning, the temperature will be 15 degrees Celsius, the wind direction is south and the wind strength is 4 meters per second. At 9 o'clock the temperature will 17 degrees, and a 6 m/s wind will blow from south-south-west, etc. The second row includes corresponding data for the area 052.

Sending the service (weather report) as a short message is more convenient to the user than sending the service as a USSD message, considering that most mobile stations only display USSD messages but do not store them.

It will be apparent to those skilled in the art that progress in technology enables the basic idea of the invention to be implemented in many ways. Therefore, the invention and its embodiments are not restricted to the above examples, but they may vary within the scope of the claims.

### REFERENCES

1. WAP Forum: Wireless Application Protocol, Wireless Application Environment Specification, version 1.1

2. ETSI GSM 11.14: Specification of the SIMApplication Toolkit for the Subscriber Identity Module—Mobile Equipment (SIM—ME) interface.

Both references are incorporated herein by reference.

1. A method of storing service configuration information, to configure a service for a mobile station, wherein the mobile station communicates with a network via a radio interface and supports storing directory entries, each directory entry comprising a first field and a second field,
the method comprising the steps of:
installing a service configuration application at a server and allocating a service identifier for the service;
receiving, at the server, preference information for the service;
generating, on the basis of the preference information and the service identifier, configuration information for the service;
formatting a directory entry such that its first field comprises a service description and the second field comprises said configuration information; and
storing the directory entry at the mobile station.

2. A method as claimed in claim 1, further comprising:
selecting a directory entry on the basis of the service description; and
sending, to said server, the configuration information comprised in the selected directory entry.

3. A method as claimed in claim 2, further comprising sending the configuration information by attempting to place a call to a telephone number similar to the configuration information.

4. A method as claimed in claim 1, wherein said formatting is performed on the network side of the radio interface.

5. A method as claimed in claim 4, further comprising sending the directory entry to the mobile station over a business card protocol.

6. A method as claimed in claim 1, further comprising formatting the configuration information as a Unstructured Supplementary Service Data [USSD] string.

7. A directory entry for a mobile station, wherein the directory entry comprises a first field and a second field such that the first field is operable to store a descriptive name and the second field is operable to store a telephone number,
wherein the first field comprises a description of a service and the second field comprises configuration information for said service.

8. A server for providing a service to a mobile station, wherein the server is adapted to generate a directory entry according to claim 7.

9. A network element for a mobile communication network, wherein the network element is adapted to process a directory entry according to claim 7.
